(19) United States
(12) Patent Application Publication
(10) Pub. No.: US 2006/0020554 A1
(43) Pub. Date: Jan. 26, 2006

(54) License proxy

(76) Inventor: Daven Walt Septon, Loveland, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/899,969

(22) Filed: Jul. 26, 2004

(51) Int. Cl. G06Q 99/00

(52) U.S. Cl. 705/59

(57) ABSTRACT

A license proxy process receives an indication that an application is licensed and, after receiving the indication, periodically transmits a heartbeat to a license server.

### BACKGROUND

License servers are used to manage licenses that enable or enhance capabilities of applications. The licenses issued by a license server may comprise “node lock” licenses that are issued to a single machine, or “floating” licenses, which are not machine specific. As illustrated in FIG. 1, an application 100 may issue a request for a license to the license server 110. If a license is available, the license server 110 may then issue the license to the application 100.

To maintain compliance with licensing agreements, the license server 110 may track the number of licenses it issues. However, if the license server 110 fails, it may lose its knowledge of issued licenses and, upon restart, its entire quantity of licenses may once again be made available. If one or more applications obtained licenses before the license server failure, and the license server reissues these licenses to additional applications after it is restarted, license over-usage becomes possible.

In order to prevent license over-usage, a heartbeat may be sent from the application 100 to the license server 110 at predetermined time intervals. If the license server 110 fails, the application 100 will not receive an acknowledgement to its heartbeat, and appropriate action can be taken.

For circuit test applications that rely on licenses provided by a FLEXlm™ license server (a license server offered by Macrovision Corporation, a Delaware Corporation having its principal place of business in Santa Clara, Calif., USA), the heartbeats provided by the circuit test applications may be executed within a few milliseconds. However, if a circuit test application is executing tests within nanoseconds, or even picoseconds, a few milliseconds is a long time, and the application's need to execute heartbeats can degrade the application's performance. Similar performance degradation is also suffered by other applications that need to provide license heartbeats during their execution of time-critical processes. In the past, programmers have merely suffered the performance “hit” of heartbeat execution; or, programmers have circumvented or disabled an application's need to provide heartbeats. In the latter case, a user of the application may fail to comply with their license requirements.

### SUMMARY OF THE INVENTION

In one embodiment, a license proxy process receives an indication that an application is licensed. After receiving the indication, a heartbeat is periodically transmitted from the license proxy process to a license server.

Other embodiments are also disclosed.

### BRIEF DESCRIPTION OF THE DRAWINGS

Illustrative and presently preferred embodiments of the invention are illustrated in the drawings, in which:

FIG. 1 illustrates a prior art system that may be used to transmit heartbeats to a license server;

FIG. 2 illustrates an exemplary embodiment of a system that uses a license proxy process to transmit heartbeats to a license server;

FIG. 3 illustrates a circuit tester that employs the license proxy process of FIG. 2;

FIG. 4 illustrates an exemplary method for transmitting heartbeats to a license server; and

FIG. 5 illustrates a variation of the FIG. 4 method.

### DETAILED DESCRIPTION OF THE INVENTION

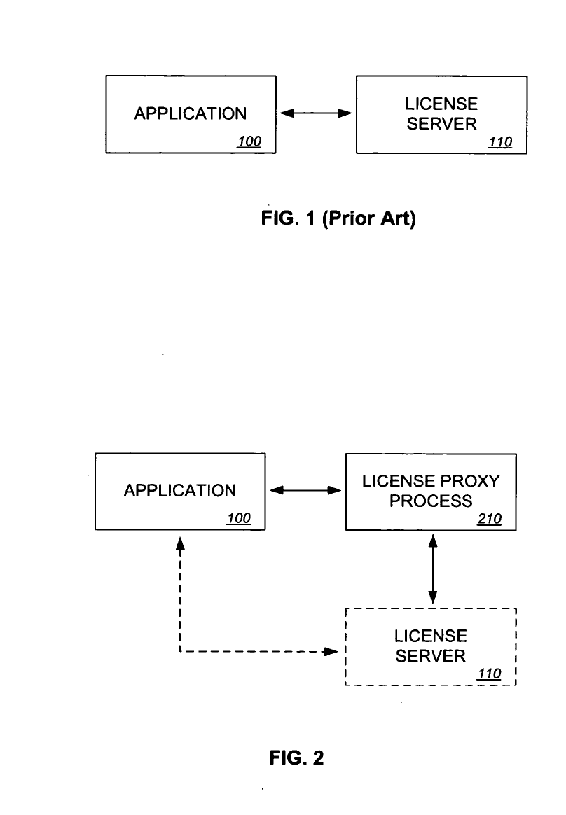

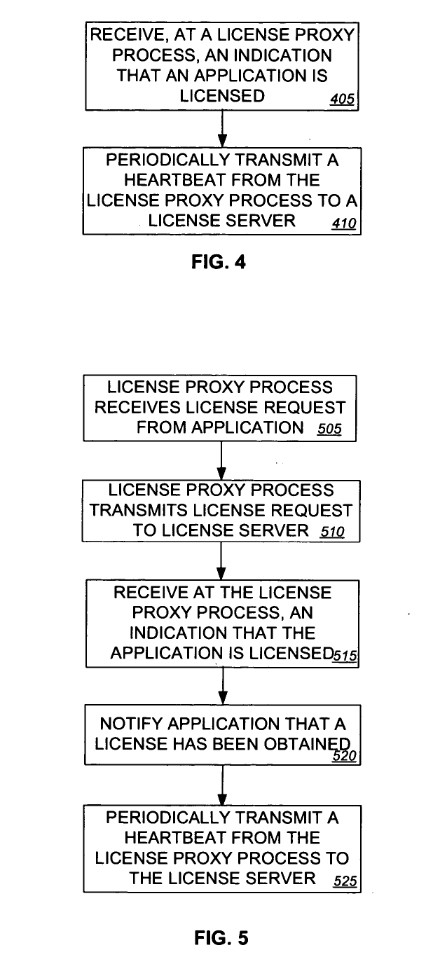

An exemplary embodiment of a system that uses a license proxy process to transmit heartbeats to a license server is illustrated in FIG. 2. The system comprises an application 100 that is communicatively coupled to a license proxy process 210. As defined herein, a communicative coupling is any sort of coupling that allows for communication between two processes. By way of example, a communicative coupling may comprise a socket or other software coupling, and/or a bus, cable, network, wireless mechanism, or other mechanism. Thus, it should be appreciated that license proxy process 210 and application 100 may reside on the same or different machines. It should also be appreciated that, in some embodiments, the application 100 may be a component (e.g., a process) of a larger application. As will be described in further detail below, with reference to FIGS. 4 and 5, the license proxy process 210 may be responsible for periodically transmitting heartbeats to a license server 110.

The license proxy process 210 is communicatively coupled to the license server 110. By way of example, the license server 110 may be a FLEXlm™ license server. However, the license server 110 may also take other forms. The license server 110 may be used to issue and control licenses for one or more applications, including application 100. Licenses issued by the license server 110 may be used to enable applications, or to enhance or govern the capabilities of applications (including the capabilities of hardware and firmware that may be controlled by the applications). In one embodiment, the license proxy process 210 is launched or initialized upon launch of the application 100.

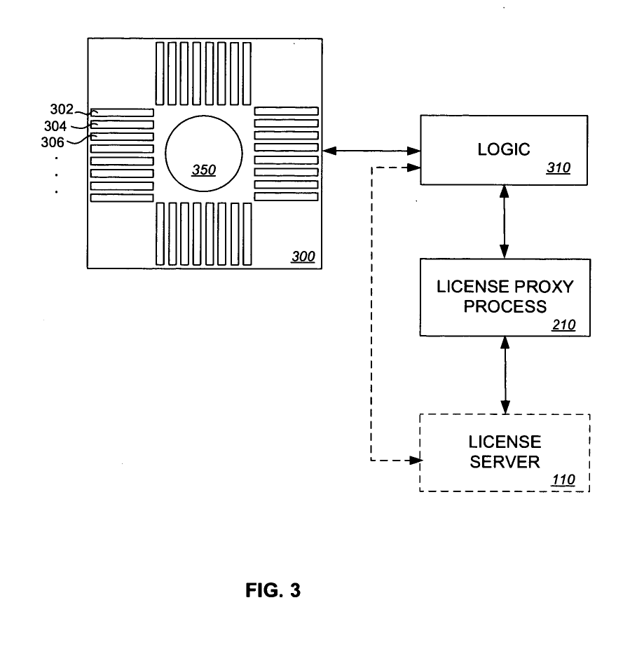

An exemplary circuit tester 300 that employs the license proxy process 210 is illustrated in FIG. 3. As shown, the circuit tester 300 may be configured to test a device 350, such as a system-on-a-chip (SOC) or other type of circuit. It should be appreciated that, at times, tester 300 may need to execute licensed applications while not coupled to a device 350.

As shown, tester 300 may comprise a plurality of boards 302-306. Each board may comprise a plurality of pins for driving inputs to, and receiving outputs from, device 350. In one embodiment, each pin may be associated with its own memory for storing test stimuli or test results (e.g., pin-specific vector information). In alternate embodiments of the tester 300, a dedicated memory may not be provided for each pin, but may instead be included for each board or other component of tester 300.

The circuit tester 300 may also comprise logic 310 that is communicatively coupled to tester 300. Logic 310 may be part of a test operating system or application that is installed on a workstation coupled to tester 300 via a communication link such as an optical link. In this manner, logic 310 may be used to control and enable features of the tester 300. In one embodiment, logic 310 may communicate with firmware on tester 300 to both 1) send tests to device 350, and 2) receive test results from device 350. In an alternate embodiment, logic 310 may be part of the firmware of tester 300.

A license may be required to enable the tester 300, or to enable or govern one or more capabilities of the tester 300. By way of example, a license may be used to enable all of the capabilities of the tester 300 or may be used to grant limited use of resources (e.g., limited rights to use boards, pins, memory or functionality (e.g., speed, GUIs, algorithms, test development tools, or debug techniques)) of the tester 300. As will be described in further detail below, with reference to FIG. 4, logic 310 may obtain one or more licenses from the license server 110 using a license proxy process 210. Alternately, logic 310 may obtain a license or licenses directly from license server 110. After a license has been obtained, the license proxy process 210 may then be used to issue heartbeat communications to the license server 110.

FIG. 4 illustrates an exemplary method that may be used to transmit heartbeats to the license server 110. The method comprises receiving 405, at a license proxy process 210, an indication that an application 100 is licensed. In one embodiment, the license indication may be received from the application 100 itself after the application 100 obtains a license from the license server 110. In an alternate embodiment, the license proxy process 210 may receive the license indication from the license server 110. It should be noted that the license proxy process 210 may be reactive, wherein it obtains licenses that are requested by the application 100, or proactive, wherein it obtains licenses in advance of when they are needed (e.g., based on believed or estimated needs of the application 100).

After receiving the license indication, the license proxy process 210 periodically transmits 410 a heartbeat to the license server 110 within a reasonable time. The heartbeat may be transmitted at predetermined time intervals so as to discover failures of the license server 110. If the license server 110 is running, the license server 110 may send an acknowledgement for each of the periodic heartbeats of the license proxy process 210. If the license server 110 fails, the license proxy process 210 will not receive an acknowledgement to its heartbeat.

In some embodiments, if an acknowledgement to a heartbeat is not received, the license under which the application 100 is running may no longer be valid (e.g., because the license server 110 may have released all of its licenses during a failure). If the license proxy process 210 determines that a license indication is no longer valid, either because it failed to receive an acknowledgement to its heartbeat, or for some other reason, the license proxy process 210 can then take appropriate action. By way of example, “appropriate action” may take the form of notifying the application 100, and/or attempting to reacquire a license from the license server 110. In some embodiments, the application 100 may be allowed to continue running, while in other embodiments, the application 100 may be halted until a valid license can be reacquired.

The heartbeat transmitted by the license proxy process 210 may be used to help prevent license over-usage. The heartbeat transmittal 410 may also serve as a notification to the license server 110 that a license is being used by the application 100, and may serve to trigger an automatic reissue of the license to the license proxy process 210 after a restart of license server 110 following a failure. It should be appreciated that by using a license proxy process 210 to communicate heartbeats to the license server 110, license over-usage may be prevented with minimal or no impact on the performance of application 100.

FIG. 5 illustrates a variation of the FIG. 4 method. In this embodiment, the license proxy process 210 first receives 505 a license request from the application 100. The license proxy process 210 then transmits 510 the license request to the license server 110. In response to the request, the license proxy process 210 receives 515 from the license server 110 an indication that the application 100 is licensed. It should be appreciated that, before issuing the license, the license server 110 may check to make sure that a license is available. In some embodiments, a license may not be available and, instead of receiving a license, the license proxy process 210 may instead receive a notification that no license is available.

Optionally, after the license indication is received 515, the license proxy process 210 may notify 520 the application 100 that a license has been obtained. In an alternate embodiment, the license proxy process 210 may actually transmit a license to the application 100.

After receiving a license indication, the license proxy process 210 may then transmit 525 heartbeats to the license server 110, as previously described.

After the application 100 has finished using a license (e.g., because logic 310 has finished executing tests on tester 300), the application 100 may send a notification to the license proxy process 210 that the license is no longer needed. The license proxy process 210 may then transmit a request to free the license to the license server 110. In one embodiment, this may be done by forwarding the notification received from the application 100. The license server 110 may then make the license available to other applications.

The methods described above may be performed by hardware components, or may be embodied in sequences of machine-executable instructions that may be used to cause a machine, such as a general-purpose or special-purpose processor, or logic circuits programmed with the instructions, to perform the actions of the methods. Alternatively, the methods may be performed by a combination of software, firmware, and/or hardware.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method, comprising:
receiving, at a license proxy process, an indication that an application is licensed; and
after receiving the indication, periodically transmitting a heartbeat from the license proxy process to a license server.

2. The method of claim 1, further comprising, prior to receiving the indication that the application is licensed:
receiving, at the license proxy process, a license request from the, application; and
transmitting the license request from the license proxy process to the license server.

3. The method of claim 2, further comprising, in response to said license proxy receiving said indication that the application is licensed, said license proxy process notifying the application that a license has been obtained.

4. The method of claim 1, wherein receiving said indication comprises receiving said indication from the application.

5. The method of claim 1, further comprising sending a notification from the license proxy process to the application if the license proxy process determines that said indication that the application is licensed is no longer valid.

6. The method of claim 5, wherein the license proxy process determines that said indication is no longer valid if the license proxy process fails to receive an acknowledgement that the license server received one of said periodic heartbeats.

7. The method of claim 1, further comprising, receiving from the license server, at the license proxy process, an acknowledgement of at least one of said periodic heartbeats.

8. The method of claim 1, further comprising receiving, at the license proxy process, a notification from the application that a license is no longer needed.

9. The method of claim 8, further comprising, after receiving the notification, transmitting a request to free the license from the license proxy process to the license server.

10. A system, comprising:
an application; and
a license proxy process, communicatively coupled to the application, to receive an indication that the application is licensed and, after receipt of said indication, periodically transmit a heartbeat to a license sever.

11. The system of claim 10, further comprising the license server, communicatively coupled to the license proxy process to issue a license for the application.

12. The system of claim 10, wherein the application comprises logic to enable features of a circuit tester.

13. The system of claim 12, further comprising the circuit tester, communicatively coupled to the logic.

14. The system of claim 13, wherein the circuit tester comprises a system-on-a-chip (SOC) tester.

15. The system of claim 10, wherein the license proxy process receives an acknowledgement of at least one of its heartbeats.

16. At least one machine-readable medium having stored thereon sequences of instructions that, when executed by a machine, cause the machine to perform the actions of:
receiving, at a license proxy process, an indication that an application is licensed; and
after receiving the indication, periodically transmitting a heartbeat from the license proxy process to a license server.

17. The machine-readable medium of claim 16, wherein said actions further comprise, prior to receiving the indication that the application is licensed:
receiving, at the license proxy process, a license request from the application; and
transmitting the license request from the license proxy process to the license server.

18. The machine-readable medium of claim 16, wherein said actions further comprise sending a notification from the license proxy process to the application if the license proxy process determines that said indication that the application is licensed is no longer valid.

19. The machine-readable medium of claim 18, wherein the license proxy process determines that said indication is no longer valid if the license proxy process fails to receive an acknowledgement that the license server received one of said periodic heartbeats.
